(19) United States
(12) Patent Application Publication
(10) Pub. No.: US 2004/0075949 A1
(43) Pub. Date: Apr. 22, 2004

(54) Method and apparatus to reduce off-track writes due to coil popping

(76) Inventors: Wallis Allen Dague, Louisville, CO (US); David Ray Lapp, Boulder, CO (US); David Paul McReynolds, Loveland, CO (US)

Correspondence Address: Derek J. Berger, Seagate Technology LLC, Intellectual Property - COL2LGL, 389 Disc Drive, Longmont, CO, 80503, US

(21) Appl. No.: 10/603,980

(22) Filed: Jun. 25, 2003

Related U.S. Application Data
(60) Provisional application No. 60/419,752, filed on Oct. 18, 2002.

(51) Int. Cl. G11B 5/55

(52) U.S. Cl. 360/265.8

(57) ABSTRACT

An actuator assembly for use in a data storage device is described that has features that reduce off-track writes due to coil popping. The fantail portion of the actuator includes thermal restraint features that engage with the over-mold, and the thermal restraint feature are positioned prevent the over-mold from separating from the actuator as a result of the over-mold and the actuator having different coefficients of thermal expansion. The thermal restraint features reduce the length of effective interface between the actuator and the over-mold acted upon by shear forces due to coefficient of thermal expansion mismatch. In one example, the thermal restraint features are holes that extend through the actuator, to allow the over-mold to flow through the holes and connect on both sides of the fantail during molding, effectively interlocking the fantail portion to the over-mold.

### RELATED APPLICATIONS

This application claims priority of U.S. provisional application Serial No. 60/419,752, filed Oct. 18, 2002.

### FIELD OF THE INVENTION

This application relates generally to data storage devices, and more particularly to a method and apparatus to reduce off-track writes in a disc drive due to coil popping.

### BACKGROUND OF THE INVENTION

The storage medium for a disc drive is a flat, circular disc capable of retaining localized magnetic fields. The data is arranged on the disc in concentric, circular paths known as tracks. A disc drive uses a magnetically sensitive head (transducer) to detect the data. The transducer is mounted upon an actuator, which is attached to a voice coil. The voice coil is immersed in a magnetic field generated by permanent magnets. This causes the actuator to move when a current is applied to the actuator.

A cost-effective and dynamically robust way to attach the voice coil to the actuator is to use an over-mold of structural plastic. The voice coil is held in a fantail section of the actuator, and the over-mold surrounds the voice coil and the fantail section of the actuator. However, when an over-mold is used to attach the voice coil to the actuator, a phenomenon known as “coil popping” can occur.

Coil popping occurs when the over-mold separates from the actuator as a result of the over-mold and the actuator each having a different coefficient of thermal expansion. During normal seek operations, current though the coil causes the temperature of the actuator to increase. This temperature increase causes the over-mold and the actuator to both expand at different rates. The actuator quickly decreases in temperature when the actuator stops at a desired location in order to perform a read or write operation, causing the actuator and the over-mold to both quickly shrink at different rates, which creates stress at the interfaces between the actuator and the over-mold. Coil popping is a physical shift that occurs in response to the stress.

When coil popping occurs, the actuator shudders, driving the transducer off track. If coil popping occurs during a write process, then data stored on adjacent tracks can be corrupted.

Accordingly there is a need for a method and apparatus to reduce off-track writes due to the phenomenon of coil popping.

### SUMMARY OF THE INVENTION

Against this backdrop, embodiments of the present invention has been developed. According to one exemplary embodiment, thermal restraint features are included in the fantail section of the actuator. The thermal restraint features are located on the fantail section to reduce the length of an interface between the over-mold and the actuator acted upon by shear forces generated by the mismatch of the coefficients of thermal expansion between the over-mold and the actuator. The thermal restraint features operate to reduce the effect of the thermal stress in order to prevent popping. According to one exemplary embodiment, the thermal restraint features are one or more spaced holes along each leg of the fantail section of the actuator that extend through the fantail section of the actuator. Over-mold material fills these holes and effectively minimizes coil popping from occurring thus minimizing off-track writes due to coil popping phenomenon.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating an embodiment of the present invention, with portions broken away to show the primary internal components.

FIG. 2 is an enlarged plan view of a fantail portion of an actuator incorporating an embodiment of the present invention, with the voice coil and over-mold depicted in dashed lines.

FIG. 3 is a perspective view of the fantail portion of the actuator shown in FIG. 2.

FIG. 4 is a perspective view of an alternative embodiment of the fantail portion of the actuator shown in FIG. 2.

### DETAILED DESCRIPTION

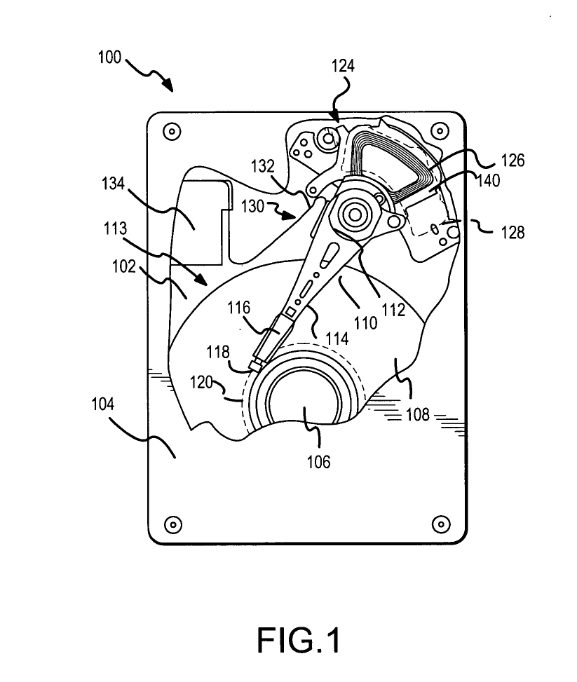

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes a fluid bearing slider enabling the head 118 to fly in close proximity above the corresponding surface of the associated disc 108.

During a seek operation, the track position of the heads 118 is controlled through the use of a voice coil motor (VCM) 124, which typically includes a voice coil 126 attached to the actuator assembly 110, as well as one or more permanent magnets 128 which establish a magnetic field in which the coil 126 is immersed. The controlled application of current to the voice coil 126 causes magnetic interaction between the permanent magnets 128 and the voice coil 126 so that the coil voice 126 moves in accordance with the well known Lorentz relationship. As the voice coil 126 moves, the actuator assembly 110 pivots about the bearing shaft assembly 112, and the heads 118 are caused to move across the surfaces of the discs 108. The voice coil 126 is covered by an over-mold 140.

The spindle motor 116 is typically de-energized when the disc drive 100 is not in use for extended periods of time. The heads 118 are moved over park zones 120 near the inner diameter of the discs 108 in the embodiment shown when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

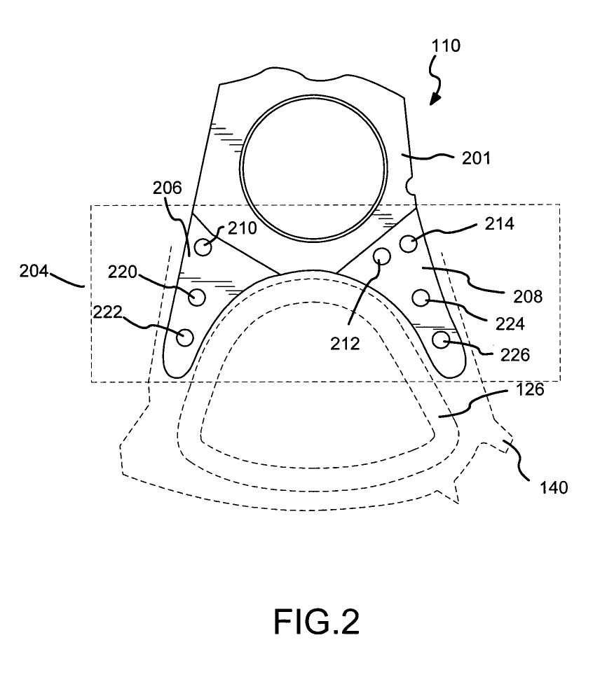

FIG. 2 is an enlarged, partial plan view of an actuator assembly 110 incorporating an embodiment of the present invention, with the voice coil and over-mold depicted in dashed lines. The actuator assembly 110 includes an actuator body 201, the voice coil 126, and the over-mold 140. The actuator body 201 includes a fantail portion 204, extending opposite the actuator arms 114. The fantail portion 204 has two spaced apart legs 206 and 208, forming a yoke for holding the voice coil 126. Leg 206 includes a bias bar 210 that is press fit through the fantail portion 204. The leg 206 also includes thermal restraint features 220 and 222, spaced along the length of the leg 206. The leg 208 includes insulated connector pins 212 and 214. The leg 208 also includes thermal restraint features 224 and 226, spaced along the leg 208. The voice coil 126, positioned between the legs 206 and 208, and the over-mold 140, formed around and over the legs 206 and 208, are shown with dotted lines so that the legs 206 and 208 within the over-mold 140 can be seen.

The voice coil 126 is configured to move (rotate) the actuator body 201 when a current is applied to the voice coil 126 via pins 212 and 214. The over-mold 140 surrounds the legs 206 and 208, and the voice coil 126 so that the voice coil 126 is coupled to the actuator body 201.

The bias bar 210 is a piece of steel that, under the influence of the magnetic field produced by magnets 128, provides a bias force on the actuator body 201 in a clockwise direction. Pins 212 and 214 are coil termination pins that are covered with a plastic insulator and are thus insulated from the fantail portion 204. Beginning and end wires of the voice coil 126 are coupled to pins 212 and 214. The voice coil 126 receives current from the disc drive servo-control system (not shown) via pins 212 and 214 for moving the actuator. The bias bar 210 and pins 212 and 214 do not limit coil popping, because they are positioned too close to the proximal end of the legs 206 and 208 to effectively limit the length of the legs 206 and 208.

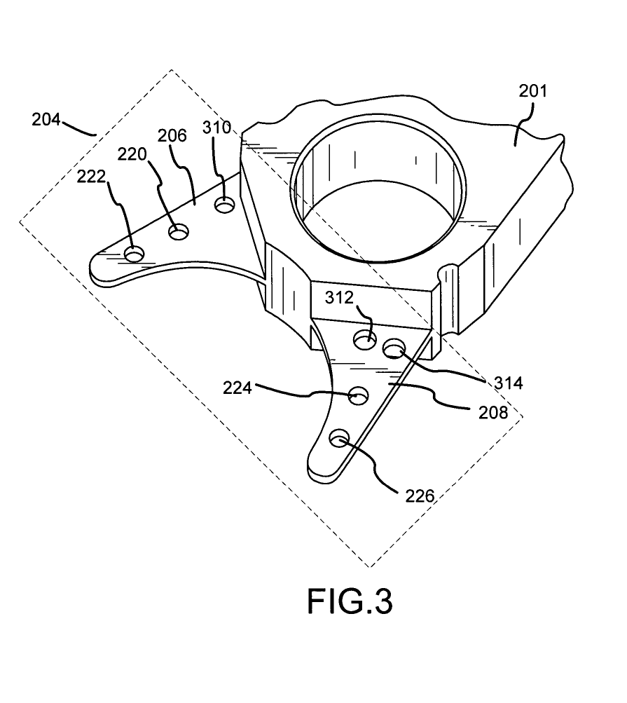

FIG. 3 is an enlarged separate perspective view of the fantail section 204 of the actuator body 201 shown in FIG. 2. FIG. 3 shows the actuator body 201 before the over-mold 140 and certain other features are added. The leg 206 has a hole 310 for receiving the bias bar 210 (shown in FIG. 2). The leg 206 also has holes 220 and 222. The leg 208 has holes 312 and 314 for receiving pins 212 and 214 (shown in FIG. 2) respectively. The leg 208 also has holes 224 and 226. The bias bar 212 and pins 214 and 216 are installed before over-molding. When the over-mold 140 is molded onto the actuator body 201, the over-mold 140 surrounds the bias bar 212, and pins 214 and 216. According to an example in which the thermal restraint features (220, 222, 224, and 226) are holes, the over-mold 140 extends through holes 220, 222, 224, and 226, interlocking the over-mold to the legs 206 and 208. This interlock effectively divides the legs 206 and 208 into short lengths in which relative movement over-mold with respect to the fantail 204 is substantially precluded. This minimizes occurrences of coil popping.

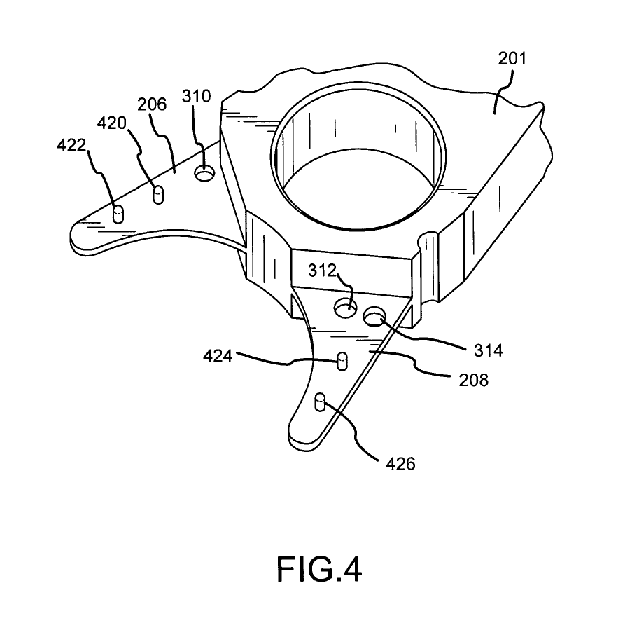

FIG. 4 is an enlarged separate perspective view of an alternative embodiment of the fantail section 204 of the actuator body 201 shown in FIG. 2. In FIG. 4, thermal restraint features 420, 422, 424, and 426 are pins that extend through the fantail portion 204 and extend vertically from the fantail portion 204. Pins 420, 422, 424, and 426 may be press fit in place, glued, or otherwise fastened to the fantail 204. Alternatively, pins 420, 422, 424, and 426, may be integrally formed in the fantail portion 204.

In the embodiment shown in FIG. 3, thermal restraint features 220, 222, 224, and 226 are holes in the actuator that extend through the fantail portion 204. The over-mold 140 extends through holes 220, 222, 224, and 226. Alternatively, as shown in FIG. 4, thermal restraint features 420, 422, 424, and 426 may be pins that extend vertically from the actuator body 201. According to yet another alternative, thermal restraint features 220 and 222 may be bridges or walls positioned across the width of the leg 206, and thermal restraint features 224 and 226 may be bridges or walls positioned across the width of the leg 208.

The over-mold 140 engages the thermal restraint features (220, 222, 224, and 226 or 420, 422, 424, and 426) to prevent the over-mold 140 from separating from the actuator body 201 as a result of the over-mold 140 and the actuator body 201 each having a different coefficient of thermal expansion. The thermal restraint features are located such that the length of the effective interface between the over-mold 140 and the actuator body 201 that is acted upon by shear forces caused by the mismatch of thermal coefficients of expansion between the actuator body 201 and the over-mold 140 is reduced. Thermal loads produced during a temperature change are transferred to the structure of the fantail portion 204 without substantial slippage. This reduces the effects of the thermal stress in order to limit coil popping.

The presence of a thermal restraint feature on the legs of the fantail portion prevents thermal expansion of the components beyond the location of the thermal restraint feature. Since the amount of thermal expansion is proportional to length, the presence of a thermal restraint feature reduces the effective length of the leg. For example, if a leg had one thermal restraint feature approximately halfway between the proximal and distal ends of the leg, the effective length of the leg would be reduced by half, and the thermal expansion of each section would be reduced by approximately half. If a leg has two thermal restraint features that divide the leg into approximately three equal parts, then thermal expansion of each section is reduced to approximately one third. (This is the configuration depicted in FIG. 2, FIG. 3, and FIG. 4). This configuration significantly decreases effects of thermal stresses caused by the mismatch of thermal coefficients of expansion between the actuator body 201 and the over-mold 140, and therefore significantly limits thermal popping. In contrast, a hole or a pin that is near the distal or proximal end of a leg of a fantail portion of an actuator does not act as a thermal restraint feature, because it has little or no effect on thermal expansion.

Although round thermal restraint features are shown in FIG. 2, FIG. 3, and FIG. 4, any shape may be used for the thermal restraint features, as the shape of the thermal restraint feature makes no appreciable difference with regard to coil popping. However, it may be more cost effective to use a round shape.

The actuator body 201 may be composed of aluminum. Alternatively, the actuator body 201 may be composed of another metal or non-metallic material.

The over-mold 140 may be composed of structural plastic. Coil popping may be reduced by utilizing an over-mold material having a coefficient of thermal expansion that closely matches the coefficient of thermal expansion of the material that the actuator is composed of. For example, the vendor RTP Company of Winona, Minn. supplies a material called 1399x94017J, and the supplier LNP ENGINEERING PLASTICS, INC. of Exton, Pa. supplies a material called PDX01787CCSGN4A421. PDX-01787CCSGN4A421 and 1399×94017J have coefficients of thermal expansion that more closely match the coefficient of thermal expansion of aluminum.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, a variety of features shapes may be used for the thermal restraint features. Also, other configurations of the thermal restraint features are possible. For example, each of the legs may have more or less thermal restraint feature than shown. As another example, the positioning of the thermal restraint features may be different, as long as the thermal restraint features are positioned to reduce the effective length of the leg that it is on. Numerous other changes may be made which will readily suggest themselves to those skilled in the art and which are encompassed in the spirit of the invention disclosed and as defined in the appended claims.

What is claimed is:

1. An actuator body for use in an actuator assembly carrying a transducer over a data storage disc, the actuator body comprising:
an actuator arm section for supporting the transducer; and
a fantail section having a first leg and a second leg, the first leg having a first thermal restraint feature, and the second leg having a second thermal restraint feature, wherein the first and second thermal restraint features are configured to engage an over-mold when the over-mold is over-molded over the fantail section, and the first and second thermal restraint features are located to prevent the over-mold from separating from the fantail section as a result of the over-mold and the actuator body each having a different coefficient of thermal expansion.

2. The actuator body as in claim 1, wherein the first leg further includes a third thermal restraint feature, and the second leg further includes a fourth thermal restraint feature, and the third and fourth thermal restraint features are located to prevent the over-mold from separating from the fantail section as a result of the over-mold and the actuator body each having a different coefficient of thermal expansion.

3. The actuator body as in claim 1, wherein the first thermal restraint feature comprises a first hole that is in the first leg and extends through the first leg, the second thermal restraint feature comprises a second hole that is in the second leg and extends through the second leg, and wherein the first hole and the second hole are arranged to engage the over-mold such that the over-mold extends through both the first hole and the second hole.

4. The actuator body as in claim 1, wherein the first thermal restraint feature comprises a first pin, and the second thermal restraint feature comprises a second pin.

5. The actuator body as in claim 1, wherein the first thermal restraint feature comprises a first wall, and the second thermal restraint feature comprises a second wall.

6. The actuator body as in claim 1, wherein the first thermal restraint feature has a circular shape, and the second thermal restraint feature has a circular shape.

7. The actuator body as in claim 1, wherein the first thermal restraint feature is positioned approximately equidistant distal and proximal ends of the first leg, and the second thermal restraint feature is positioned approximate equidistant distal and proximal ends of the second leg.

8. The actuator body as in claim 2, wherein the first thermal restraint feature comprises a first hole that is in the first leg and extends through the first leg, the second thermal restraint feature comprises a second hole that is in the second leg that extends through the second leg, the third thermal restraint feature comprises a third hole that is in the first leg and extends through the first leg, the second thermal restraint feature comprises a fourth hole that is in the second leg and extends through the second leg, and wherein the first, second, third, and fourth holes are arranged to engage the over-mold such that the over-mold extends through the first, second, third, and fourth holes.

9. The actuator body as in claim 2, wherein the distance from the distal end of the first leg and the thermal restraint feature that is closest the distal end of the first leg, the distance from the proximal end of the first leg and the thermal restraint feature that is closest to the proximal end of the first leg, and the distance of each of the thermal restraint features on the first leg from each other are all approximately the same, and wherein the distal end of the second leg and the thermal restraint feature that is closest the distal end of the second leg, the distance from the proximal end of the second leg and the thermal restraint feature that is closest to the proximal end of the second leg, and the distance of each of the thermal restraint features on the second leg from each other are all approximately the same.

10. An actuator assembly for use in a data storage device comprising:
a voice coil;
an actuator having a fantail section including a first leg and a second leg forming a yoke for receiving the voice coil therebetween, wherein the first leg has a first thermal restraint feature, and the second leg has a second thermal restraint feature; and
an over-mold on the fantail section that surrounds the first and second legs and holds the voice coil, wherein the first and second thermal restraint features are located such that the over-mold engages with the first and second thermal restraint features to prevent the over-mold from separating from the actuator as a result of the over-mold and the actuator each having a different coefficient of thermal expansion.

11. The actuator assembly as in claim 10, wherein the first leg further includes a third thermal restraint feature, and the second leg further includes a fourth thermal restraint feature, and the third and fourth thermal restraint features are located to prevent the over-mold from separating from the fantail section as a result of the over-mold and the actuator each having a different coefficient of thermal expansion.

12. The actuator assembly as in claim 10, wherein the first thermal restraint feature comprises a first hole that is in the first leg and extends through the first leg, the second thermal restraint feature comprises a second hole that is in the second leg and extends through the second leg, and the over-mold extends through both the first hole and the second hole.

13. The actuator assembly as in claim 10, wherein the first thermal restraint feature comprises a first pin, and the second thermal restraint feature comprises a second pin.

14. The actuator assembly as in claim 10, wherein the first thermal restraint feature comprises a first hole that is in the first leg and extends through the first leg, the second thermal restraint feature comprises a second hole that is in the second leg that extends through the second leg, the third thermal restraint feature comprises a third hole that is in the first leg and extends through the first leg, the second thermal restraint feature comprises a fourth hole that is in the second leg and extends through the second leg, and the over-mold extends through the first, second, third, and fourth holes.

15. The actuator assembly as in claim 14, wherein the distance from the distal end of the first leg and the hole that is closest the distal end of the first leg, the distance from the proximal end of the first leg and hole that is closest to the proximal end of the first leg, and the distance of each of the holes on the first leg from each other are all approximately the same, and wherein the distal end of the second leg and the hole that is closest the distal end of the second leg, the distance from the proximal end of the second leg and the hole that is closest to the proximal end of the second leg, and the distance of each of the holes on the second leg from each other are all approximately the same.

16. An actuator body for use in an actuator assembly carrying a transducer over a data storage disc, the actuator body comprising:
an actuator arm section for supporting the transducer; and
a means for reducing thermal stress that is configured to engage an over-mold, wherein the reducing means is configured to reduce thermal stress caused by the over-mold and the actuator each having a different coefficient of thermal expansion.

17. The actuator body as in claim 16, wherein the reducing means comprises a plurality of holes in the actuator body, wherein each of the plurality of holes are located such that the over-mold engages with the plurality of holes to prevent the over-mold from separating from the actuator as a result of the over-mold and the actuator each having a different coefficient of thermal expansion, and each of the plurality of holes extend through the actuator.

18. The actuator body as in claim 16, wherein each of the plurality of holes has a circular shape.

19. The actuator body as in claim 16, wherein the actuator body further comprises a fantail section, the fantail section comprises a first and second leg, a first of the plurality of holes is positioned on the first leg, and a second of the plurality of holes is positioned on the second leg.

20. The actuator body as in claim 16, wherein the reducing means comprises a plurality of pins in the actuator, wherein each of the plurality of pins are located such that the over-mold engages with the plurality of pins to prevent the over-mold from separating from the actuator as a result of the over-mold and the actuator each having a different coefficient of thermal expansion.
